(19) United States
(12) Patent Application Publication
(10) Pub. No.: US 2025/0355413 A1
(43) Pub. Date: Nov. 20, 2025

(54) SCENARIO PARAMETER OPTIMIZATION DEVICE, SCENARIO PARAMETER OPTIMIZATION METHOD, STORAGE MEDIUM HAVING STORED THEREIN A SCENARIO PARAMETER OPTIMIZATION PROGRAM, AND CONTROL LOGIC INSPECTION SYSTEM

(71) Applicant: Mitsubishi Electric Corporation, Tokyo (JP)

(72) Inventor: Takayuki ITSUI, Tokyo (JP)

(73) Assignee: Mitsubishi Electric Corporation, Tokyo (JP)

(21) Appl. No.: 19/283,501

(22) Filed: Jul. 29, 2025

Related U.S. Application Data
(63) Continuation of application No. PCT/JP2023/012068, filed on Mar. 27, 2023.

(51) Int. Cl. G05B 13/04

(52) U.S. Cl. CPC G05B 13/044

(57) ABSTRACT

A scenario parameter optimization device includes: an object function value calculation unit that calculates an object function value of a predetermined event, and an event occurrence time at which the predetermined event occurs on the basis of an execution result of a simulation test of a scenario including a first agent and a second agent, executed on the basis of a scenario parameter; a responsibility determination unit that determines whether or not the first agent is responsible for the occurrence of the predetermined event from a situation at a responsibility determination time before the event occurrence time, and outputs a result of the determination as a responsibility determination result; and a scenario parameter optimization unit that optimizes the scenario parameter in such a manner that the object function value decreases and the first agent is determined to be responsible for the occurrence of the predetermined event.

### CROSS REFERENCE TO RELATED APPLICATION

This application is a Continuation of PCT International Application No. PCT/JP2023/012068, filed on Mar. 27, 2023, which is hereby expressly incorporated by reference into the present application.

### TECHNICAL FIELD

The present disclosure relates to a scenario parameter optimization technique.

### BACKGROUND ART

A technique for causing an agent such as an automobile or a robot to automatically travel has been developed. In order to cause the agent to automatically travel, it is necessary to inspect a control logic for controlling the agent in various scenarios simulating a real environment. As a control logic inspection method, there is a method called search-based testing. The search-based testing means a method for searching for a scenario to be inspected using a metaheuristic optimization technique. Patent Literature 1 discloses a technique based on the search-based testing. Patent Literature 1 discloses a technique of setting a scenario parameter used in a simulation test of a program to be inspected by optimization processing.

### CITATION LIST

### Patent Literature

Patent Literature 1: JP 2018-190230 A

### SUMMARY OF INVENTION

### Technical Problem

In the technique of Patent Literature 1, a scenario in which a plurality of agents is present is not assumed, and therefore there is a problem that it is difficult to optimize a scenario parameter used in a scenario in which a plurality of agents is present.

The present disclosure has been made in order to solve such a problem, and an object of the present disclosure is to provide a scenario parameter optimization technique capable of optimizing a scenario parameter used in a scenario in which a plurality of agents is present.

### Solution to Problem

An aspect of a scenario parameter optimization device according to an embodiment of the present disclosure includes: processing circuitry to receive an execution result of a simulation test of a scenario including a first agent and a second agent, executed on a basis of a scenario parameter, and to calculate an object function value of a predetermined event from an object function expressing the predetermined event, and an event occurrence time at which the predetermined event occurs on a basis of the execution result; to determine whether or not the first agent is responsible for the occurrence of the predetermined event from a situation at a responsibility determination time before the calculated event occurrence time on a basis of the execution result and the calculated event occurrence time, and to output a result of the determination as a responsibility determination result; and to optimize the scenario parameter in such a manner that the calculated object function value decreases and the first agent is determined to be responsible for the occurrence of the predetermined event on a basis of the calculated object function value and the output responsibility determination result.

### Advantageous Effects of Invention

According to the scenario parameter optimization unit according to the embodiment of the present disclosure, it is possible to optimize a scenario parameter used in a scenario in which a plurality of agents is present.

### BRIEF DESCRIPTION OF DRAWINGS

FIG. 1 is a functional block diagram illustrating a configuration example of a scenario parameter optimization device and a control logic inspection system according to a first embodiment.

FIG. 2A is a diagram illustrating a configuration example of hardware of the scenario parameter optimization device and the control logic inspection system.

FIG. 2B is a diagram illustrating a configuration example of hardware of the scenario parameter optimization device and the control logic inspection system.

FIG. 3 is a diagram illustrating a part of a flowchart of a scenario parameter optimization method. More specifically, FIG. 3 illustrates operation performed by an object function value calculation unit of the scenario parameter optimization device.

FIG. 4 is a diagram illustrating a part of the flowchart of the scenario parameter optimization method. More specifically, FIG. 4 illustrates operation performed by a responsibility determination unit of the scenario parameter optimization device.

FIG. 5 is a diagram illustrating a part of the flowchart of the scenario parameter optimization method. More specifically, FIG. 5 illustrates operation performed by the responsibility determination unit of the scenario parameter optimization device.

FIG. 6 is a diagram illustrating a part of the flowchart of the scenario parameter optimization method. More specifically, FIG. 6 illustrates operation performed by a scenario parameter optimization unit of the scenario parameter optimization device.

FIG. 7A is a diagram for explaining operation of the scenario parameter optimization device in a case where a lateral distance is equal to or smaller than a vehicle width. FIG. 7B is a diagram for explaining operation of the scenario parameter optimization device in a case where the lateral distance is larger than the vehicle width.

### DESCRIPTION OF EMBODIMENTS

Hereinafter, various embodiments in the present disclosure will be described in detail with reference to the attached drawings. Note that constituent elements denoted by the same or similar reference numerals throughout the drawings have the same or similar configurations or functions, and redundant description of such constituent elements will be omitted.

In addition, in the present disclosure, the term “or” is used in the meaning of comprehensive logical sum unless otherwise specified. When the term “or” is used in the meaning of exclusive logical sum, it is clearly indicated.

### First Embodiment

### <Configuration>

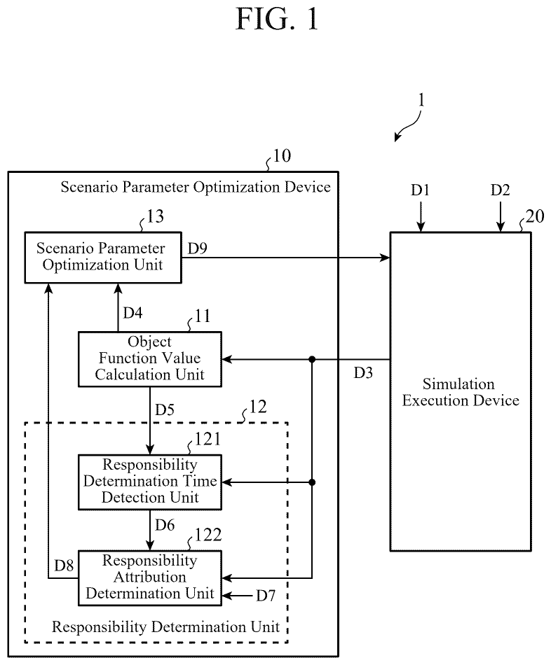

A scenario parameter optimization device and a control logic inspection system according to a first embodiment of the present disclosure will be described with reference to FIG. 1. FIG. 1 is a functional block diagram illustrating a configuration example of a scenario parameter optimization device 10 according to the first embodiment and a control logic inspection system 1 including the scenario parameter optimization device 10. As illustrated in FIG. 1, the control logic inspection system 1 includes the scenario parameter optimization device 10 and a simulation execution device 20. The simulation execution device 20 is a device that inspects a control logic program using a scenario. The scenario parameter optimization device 10 is a device that optimizes a scenario parameter used in a scenario used when the simulation execution device 20 performs an inspection. Hereinafter, each device will be described.

(Simulation execution device)

The simulation execution device 20 is a device that receives scenario setting D1, a value of a scenario parameter used in the scenario setting D1, and a control logic program D2 as inputs, and executes a simulation test that operates the control logic program D2 under a scenario specifically set by the value of the scenario parameter. The simulation execution device 20 executes the simulation test according to a calculation program and data for the simulation test (not illustrated). The calculation program and data (not illustrated) include a sensor model such as a radar or a camera.

The control logic defines a behavior of a control target agent that is a control target. More specifically, the control logic controls the behavior of the control target agent on the basis of a result of recognition regarding the outside world recognized by the control target agent. For example, when recognizing an object in a traveling direction of the control target agent, the control logic decreases a traveling speed of the control target agent or changes the traveling direction of the control target agent in order to prevent collision with the recognized object. A control amount is determined, for example, every 100 ms. The control logic program D2 is a program for implementing the control logic.

In the present disclosure, an agent to be controlled by the control logic is referred to as a control target agent, and an agent other than the control target agent and present around the control target agent is referred to as a surrounding agent. In the present disclosure, the control target agent and the surrounding agent may be more generally referred to as a first agent and a second agent, respectively. Examples of the agent include any mobile object such as a vehicle, a robot, or a drone.

The scenario means development over time between multiple scenes. A certain scene is a term defined at a certain time. In a case where the agent is a vehicle, the scenario includes a road situation and a target position of a control target vehicle. As an example of the scenario in a case where the agent is a vehicle, for example, 1) a scenario in which a control target vehicle travels in a certain lane at a certain time, a surrounding vehicle travels 60 m ahead of the control target vehicle in a lane adjacent to the lane, and the surrounding vehicle changes its lane to a position 40 m ahead of the control target vehicle within a period from the time to a predetermined time, or 2) a scenario in which a control target vehicle travels in a certain lane at a certain time, a surrounding vehicle travels 20 m ahead of the control target vehicle in a lane adjacent to the lane, and the control target vehicle changes its lane to a position 40 m behind the surrounding vehicle within a period from the time to a predetermined time is considered.

Setting for at least one scenario parameter is given to the scenario. Examples of the scenario parameter include an initial speed of the control target agent, and an initial position, an initial speed, a target speed, and an acceleration of the surrounding agent. In a case where the agent is a vehicle, a target lane may be included as the scenario parameter. An initial value of a scenario parameter D9 is given to the scenario parameter optimization device 10 by, for example, a user input, and the initial value of the scenario parameter D9 is output to the simulation execution device 20. The simulation execution device 20 optimizes a value of the scenario parameter D9 on the basis of an object function value D4 and a responsibility determination result D8.

The simulation execution device 20 executes a simulation test for operation of the control target agent by the control logic program D2 under the simulated scenario setting D1 specifically defined by the scenario parameter. The simulation execution device 20 outputs a simulation execution result D3, which is an execution result of the simulation test, to the scenario parameter optimization device 10. The simulation execution result D3 includes a movement log in which movements of the control target agent and the surrounding agents are recorded. The movement log includes, for example, a situation of the surrounding agent recognized by the control target agent in addition to the position, speed, and acceleration of each agent at each time during the simulation test.

### (Scenario Parameter Optimization Device)

The scenario parameter optimization device 10 is a device that receives the simulation execution result D3, analyzes the simulation execution result D3, and optimizes a scenario parameter used in the scenario setting D1. In order to implement such a function, the scenario parameter optimization device 10 includes an object function value calculation unit 11, a responsibility determination unit 12, and a scenario parameter optimization unit 13. The responsibility determination unit 12 includes a responsibility determination time detection unit 121 and a responsibility attribution determination unit 122. Hereinafter, each functional unit will be described in detail.

### (Object Function Value Calculation Unit)

The object function value calculation unit 11 calculates an object function value D4 of a predetermined event from an object function expressing the predetermined event on the basis of the simulation execution result D3, and outputs the calculated object function value D4 to the scenario parameter optimization unit 13. The predetermined event is, for example, an event in which an inter-agent distance between the control target agent and the surrounding agent is minimized by a decrease in the inter-agent distance with an elapse of time. In addition, in a case where the event in which the inter-agent distance is minimized is a predetermined event, the object function expressing the predetermined event is a function expressing a distance between the agents. A minimum value of the inter-agent distance being smaller than a certain threshold means that a problem of collision between the agents occurs.

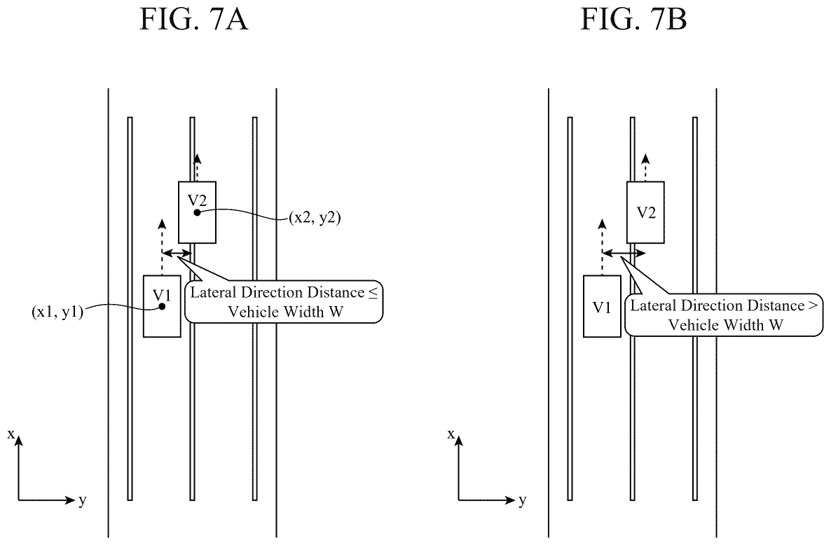

The calculation of the object function value D4 will be specifically described with reference to FIG. 7. In FIGS. 7A and 7B, the control target agent is referred to as a control target vehicle V1, and the surrounding agent is referred to as a surrounding vehicle V2. Centers of gravity of the control target vehicle V1 and the surrounding vehicle V2 are represented by (x1, y1) and (x2, y2), respectively. As in a case of FIG. 7A, in a case where a distance |y2−y1| in a lateral direction y between the control target vehicle V1 and the surrounding vehicle V2 is equal to or less than a vehicle width W, the object function value calculation unit 11 calculates, as the object function value D4, a minimum value that is a distance at the time of closest approach of a distance |x2−x1| in a longitudinal direction x that is a traveling direction of the vehicles. For example, a fixed value of 2000 mm may be used as the vehicle width W. In a case where a vehicle width W1 of the control target vehicle V1 is different from a vehicle width W2 of the surrounding vehicle V2, an average value of the vehicle width W1 and the vehicle width W2 may be used as the vehicle width W.

Meanwhile, as in a case of FIG. 7B, in a case where the distance |y2−y1| in the lateral direction y is larger than the vehicle width W, the control target vehicle V1 and the surrounding vehicle V2 do not collide with each other, and therefore the object function value calculation unit 11 does not calculate an inter-vehicle distance when the control target vehicle V1 and the surrounding vehicle V2 are closest to each other, and regards a value (for example, 10,000 m) large enough not to affect an optimization result as the inter-vehicle distance.

In addition, the object function value calculation unit 11 outputs a time at which data used to calculate the object function value D4 was acquired to the responsibility determination time detection unit 121 as an event occurrence time D5. That is, the event occurrence time D5 is an occurrence time of a predetermined event.

### (Responsibility Determination Unit)

The responsibility determination unit 12 is a functional unit that determines whether a control target agent is responsible for occurrence of a predetermined event. More specifically, the responsibility determination unit 12 determines whether or not the control target agent is responsible for occurrence of a predetermined event from a situation at a responsibility determination time D6 before the event occurrence time D5 on the basis of the simulation execution result D3 and the event occurrence time D5, and outputs a result of the determination as the responsibility determination result D8. In order to implement such a function, the responsibility determination unit 12 includes the responsibility determination time detection unit 121 and the responsibility attribution determination unit 122.

### (Responsibility Determination Time Detection Unit)

The responsibility determination time detection unit 121 detects, as a responsibility determination time candidate, a time at which a behavior of the surrounding agent leading to the occurrence of the predetermined event occurred before the event occurrence time D5 on the basis of the simulation execution result D3, determines the responsibility determination time D6 on the basis of the detected responsibility determination time candidate, and outputs the determined responsibility determination time D6 to the responsibility attribution determination unit 122.

Here, an example of the behavior of the surrounding agent leading to the occurrence of the predetermined event will be described. In order to describe the example, a vehicle is assumed as the agent, and a scenario in which two vehicles of a control target vehicle and a surrounding vehicle travel on a road is assumed. In addition, as the predetermined event, an event in which an inter-vehicle distance between the control target vehicle and the surrounding vehicle becomes a minimum value with an elapse of time is assumed. Under such assumptions, examples of such a behavior of the surrounding agent may include course change (lane change), acceleration, and deceleration.

More specifically, the example related to the course change is a case where, while the control target vehicle is traveling in a certain lane, the surrounding vehicle traveling in an adjacent lane cuts in front of the control target vehicle and change its lane. A scenario in which the surrounding vehicle decelerate before and after the lane change may be assumed.

Another example related to the course change is a case where, after the control target vehicle starts to change its lane from a first lane to a second lane adjacent to the first lane, the surrounding vehicle traveling in a third lane adjacent to the second lane change its lane to the second lane. A scenario in which the surrounding vehicle decelerate before and after the lane change may be assumed.

An example of the acceleration is a case where, after the control target vehicle traveling in a certain lane starts to change its lane to a lane adjacent to the lane, the surrounding vehicle traveling on the adjacent lane and located behind the control target vehicle accelerates.

An example of the deceleration is a case where the surrounding vehicle traveling in the same lane as the control target vehicle and located ahead of the control target vehicle suddenly decelerates.

The behaviors of the surrounding vehicle in these examples shorten an inter-vehicle distance between the control target vehicle and the surrounding vehicle. The responsibility determination time detection unit 121 detects a time at which such a behavior of the surrounding agent occurred as a responsibility determination time candidate. In a case where the surrounding agent performs a plurality of behaviors as in a case where the surrounding agent decelerates after changing its lane, the responsibility determination time detection unit 121 calculates, as a responsibility determination time candidate, a time that is the latest before the event occurrence time D5 among times at which a behavior change of the surrounding agent occurs. The responsibility determination time detection unit 121 determines the responsibility determination time D6 on the basis of the responsibility determination time candidate, and outputs the determined responsibility determination time D6 to the responsibility attribution determination unit 122. The determination of the responsibility determination time D6 based on the responsibility determination time candidate will be described later.

### (Responsibility Attribution Determination Unit)

The responsibility attribution determination unit 122 determines whether or not the control target agent is responsible for occurrence of the predetermined event on the basis of a situation of the responsibility determination time D6 in the simulation execution result D3, and outputs a result of the determination to the scenario parameter optimization unit 13 as the responsibility determination result D8. The situation means physical quantities of the control target agent and the surrounding agent. Examples of the physical quantity include a position, a speed, and acceleration. A determination method will be described later.

### (Scenario Parameter Optimization Unit)

The scenario parameter optimization unit 13 optimizes the scenario parameter D9 in such a manner that the control target agent is responsible for occurrence of the predetermined event and the object function value D4 decreases on the basis of the object function value D4 and the responsibility determination result D8. As an optimization method, there is a heuristic method such as Hill Climbing, Simulated Annealing, or Genetic Algorithms.

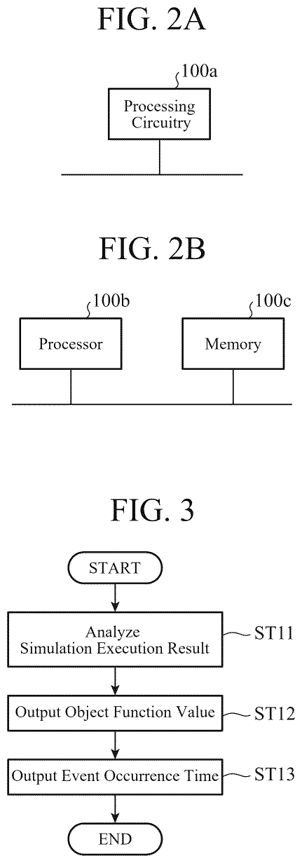

Next, hardware configuration examples of the scenario parameter optimization device 10 and the simulation execution device 20 will be described with reference to FIGS. 2A and 2B. A function of each of the devices is implemented by a processing circuitry. The processing circuitry may be a dedicated processing circuitry 100a as illustrated in FIG. 2A or a computer including a memory 100c and a processor 100b as illustrated in FIG. 2B. The processor 100b reads a program stored in the memory 100c and executes the read program.

In a case where the processing circuitry is the dedicated processing circuitry 100a, for example, a single circuit, a composite circuit, a programmed processor, a parallel programmed processor, an application specific integrated circuit (ASIC), a field-programmable gate array (FPGA), or a combination thereof corresponds to the dedicated processing circuitry 100a. The function of each of the devices may be implemented by a plurality of separate processing circuits, or a plurality of functions may be collectively implemented by a single processing circuit.

In a case where the processing circuitry is the processor 100b, the function of each of the devices is implemented by software, firmware, or a combination of software and firmware. The software and the firmware are each described as a program and stored in the memory 100c. The processor 100b implements the function of each of the devices by reading and executing the program stored in the memory. Here, examples of the memory 100c include a nonvolatile or volatile semiconductor memory such as random access memory (RAM), read-only memory (ROM), flash memory, erasable programmable read only memory (EPROM), or electrically erasable programmable read-only memory (EEPROM), a magnetic disk, a flexible disk, an optical disc, a compact disc, a mini disc, and DVD.

### <Operation>

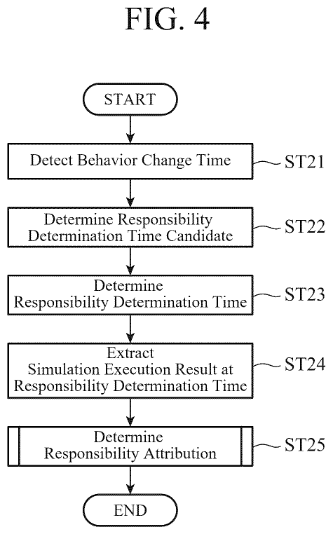

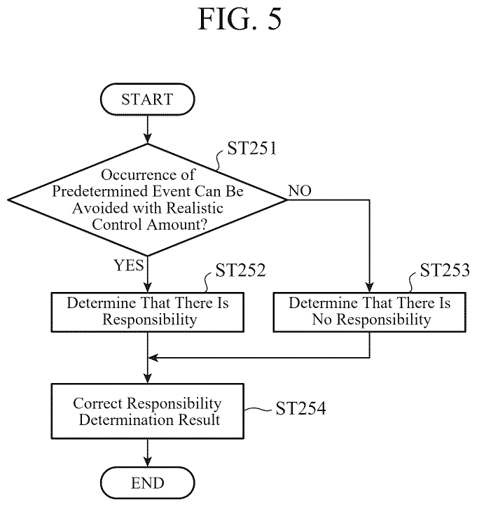

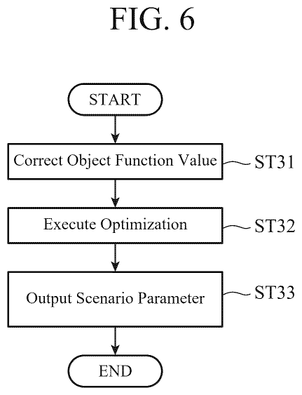

Next, operation of the scenario parameter optimization device 10 will be described with reference to FIGS. 3 to 6. FIG. 3 illustrates operation performed by the object function value calculation unit 11 of the scenario parameter optimization device 10. FIGS. 4 and 5 illustrate operation performed by the responsibility determination unit 12 of the scenario parameter optimization device 10. FIG. 6 illustrates operation performed by the scenario parameter optimization unit 13 of the scenario parameter optimization device 10. Hereinafter, a detailed description will be given with reference to the drawings.

Operation performed by the object function value calculation unit 11 will be described with reference to FIG. 3. In step ST11, the object function value calculation unit 11 analyzes the simulation execution result D3 output from the simulation execution device 20. The simulation execution result D3 includes a movement log such as a travel log or a flight log in which position information of a control target agent and at least one surrounding agent is recorded. In a case where there is a plurality of surrounding agents, the simulation execution result D3 includes a movement log of each of the surrounding agents. The object function value calculation unit 11 analyzes the simulation execution result D3, and obtains a minimum value of a distance from the control target agent to at least one surrounding agent. In a case where there is a plurality of surrounding agents, the object function value calculation unit 11 obtains a minimum value of a distance to each of the surrounding agents.

In step ST12, the object function value calculation unit 11 calculates an object function value from the obtained minimum value of one or more distances to the surrounding agent, and outputs the calculated object function value D4. In a case where only a single surrounding agent is present, the object function value D4 is a minimum value of a distance to the surrounding agent. In addition, in a case where there is a plurality of surrounding agents, the object function value D4 may be a multi-value that exists as many as the number of surrounding agents, or may be a single value of only a value that minimizes a minimum value of a distance to the control target agent. The object function value calculation unit 11 outputs the calculated object function value D4 to the scenario parameter optimization unit 13.

In step ST13, the object function value calculation unit 11 outputs, as the event occurrence time D5, a time at which data used to calculate the object function value D4 was acquired, that is, a time at which a distance between the control target agent and the surrounding agents is minimized to the responsibility determination time detection unit 121.

Operation performed by the responsibility determination unit 12 including the responsibility determination time detection unit 121 and the responsibility attribution determination unit 122 will be described with reference to FIGS. 4 and 5. In step ST21, the responsibility determination time detection unit 121 analyzes the simulation execution result D3 output from the simulation execution device 20, and detects a behavior change time at which a behavior change of each surrounding agent occurred. Examples of the behavior change include lane change, acceleration, and deceleration when the surrounding agent is, for example, an automobile.

In step ST22, the responsibility determination time detection unit 121 determines, for each surrounding agent, the latest behavior change time before the event occurrence time D5 among behavior change times of each surrounding agent as a responsibility determination time candidate.

In step ST23, the responsibility determination time detection unit 121 analyzes the simulation execution result D3, detects, for each surrounding agent, a recognition start time at which the control target agent started to recognize the surrounding agent before the event occurrence time D5, calculates a later one of the responsibility determination time candidate and the recognition start time as the responsibility determination time D6, and outputs the calculated responsibility determination time D6 to the responsibility attribution determination unit 122. For example, in a case where the surrounding vehicle present ahead of the control target vehicle on an adjacent lane changes its lane and cuts in front of the control target vehicle, the recognition start time at which the control target vehicle starts to recognize that the surrounding vehicle enters the same lane as the control target vehicle may be later than the responsibility determination time candidate at which the surrounding vehicle starts to change its lane. In such an example, the responsibility determination time detection unit 121 calculates the later recognition start time as the responsibility determination time D6.

In step ST24, the responsibility attribution determination unit 122 extracts data of the surrounding agent at the responsibility determination time D6 calculated by the responsibility determination time detection unit 121 from the simulation execution result D3 output from the simulation execution device 20.

In step ST25, the responsibility attribution determination unit 122 determines presence or absence of responsibility of the control target agent in a relationship with each surrounding agent for occurrence of the predetermined event, and outputs a result of the determination to the scenario parameter optimization unit 13 as the responsibility determination result D8.

FIG. 5 is a flowchart for explaining in detail processing by the responsibility attribution determination unit 122 in step ST25. In step ST251, on the basis of the data of the surrounding agent at the responsibility determination time D6, it is determined whether or not the control target agent could avoid occurrence of the predetermined event with a realistic control amount in a period from the responsibility determination time D6 to the event occurrence time D5. For example, one or both of a value of deceleration and a value of turning angular velocity necessary for collision avoidance is calculated according to the law of motion, and in a case where the calculated value exceeds a predetermined threshold D7, it is determined that occurrence of the predetermined event cannot be avoided with a realistic control amount (NO in step ST251). In a case of deceleration, as the threshold D7, for example, a value of about 0.75 G, which is a braking force that can be generated by a skilled driver, or a value of about 0.85 G, which is a braking force when a collision damage reduction brake device is activated, can be used. On the other hand, when the calculated value is equal to or less than the predetermined threshold D7, it is determined that occurrence of the predetermined event can be avoided with a realistic control amount (YES in step ST251).

If YES in step ST251, the process proceeds to step ST252, and in step ST252, it is determined that the control target agent is responsible.

If NO in step ST251, the process proceeds to step ST253, and in step ST253, it is determined that the control target agent is not responsible.

In step ST254, a behavior change of the control target agent is detected from the simulation execution result D3 output from the simulation execution device 20, and in a case where a time of the detected behavior change is later than the responsibility determination time D6, the determination result is corrected in such a manner as to determine that the control target agent is responsible. For example, in a case where a surrounding vehicle present ahead of the control target vehicle in an adjacent lane decelerates and then the control target vehicle changes its lane to the adjacent lane, it is regarded that the control target vehicle is responsible.

Operation performed by the scenario parameter optimization unit 13 will be described with reference to FIG. 6. In step ST31, the scenario parameter optimization unit 13 corrects the object function value D4 output from the object function value calculation unit 11 on the basis of the responsibility determination result D8 output from the responsibility attribution determination unit 122. For example, in a scenario in which, for example, surrounding vehicles a, b, and c are present as surrounding agents, in a case where it is determined that a control target agent is not responsible for occurrence of a predetermined event with respect to a certain surrounding agent, for example, the surrounding vehicle b, a penalty value is added to an object function value fb corresponding to the surrounding vehicle b, whereby a similar scenario parameter value is less likely to occur in the subsequent optimization.

In step ST32, the scenario parameter optimization unit 13 updates a value of the scenario parameter by executing optimization. As an optimization method, there is a heuristic method such as Hill Climbing, Simulated Annealing, or Genetic Algorithms.

In step ST33, the scenario parameter optimization unit 13 outputs the updated value of the scenario parameter to the simulation execution device 20.

As described above, the scenario parameter optimization device 10 assumes a scenario in which a plurality of agents including a control target agent and a surrounding agent is present. Under the assumed scenario, the scenario parameter optimization device 10 optimizes the scenario parameter in such a manner that the control target agent is responsible for occurrence of the predetermined event during the simulation test of the control logic program and the object function value decreases. Therefore, the scenario parameter optimization device 10 can effectively search for a scenario desired to be used as a test case in a simulation test.

Note that the embodiments can be combined, and each of the embodiments can be appropriately modified or omitted.

### INDUSTRIAL APPLICABILITY

The scenario parameter optimization device of the present disclosure can be used as a device for effectively searching for a scenario used for inspecting a control logic program for controlling an agent such as an autonomous vehicle.

### REFERENCE SIGNS LIST

1: Control logic inspection system, 10: Scenario parameter optimization device, 11: Object function value calculation unit, 12: Responsibility determination unit, 13: Scenario parameter optimization unit, 20: Simulation execution device, 100a: Processing circuitry, 100b: Processor, 100c: Memory, 121: Responsibility determination time detection unit, 122: Responsibility attribution determination unit

What is claimed is:

1. A scenario parameter optimization device comprising:
processing circuitry
to receive an execution result of a simulation test of a scenario including a first agent and a second agent, executed on a basis of a scenario parameter, and to calculate an object function value of a predetermined event from an object function expressing the predetermined event, and an event occurrence time at which the predetermined event occurs on a basis of the execution result;
to determine whether or not the first agent is responsible for the occurrence of the predetermined event from a situation at a responsibility determination time before the calculated event occurrence time on a basis of the execution result and the calculated event occurrence time, and to output a result of the determination as a responsibility determination result; and
to optimize the scenario parameter in such a manner that the calculated object function value decreases and the first agent is determined to be responsible for the occurrence of the predetermined event on a basis of the calculated object function value and the output responsibility determination result.

2. The scenario parameter optimization device according to claim 1, wherein
the processing circuitry detects the responsibility determination time on a basis of the execution result and the calculated event occurrence time.

3. The scenario parameter optimization device according to claim 2, wherein
the processing circuitry calculates, as a responsibility determination time candidate, a time that is the latest before the event occurrence time among times at which a behavior change of the second agent occurs and detects the calculated responsibility determination time candidate as the responsibility determination time.

4. The scenario parameter optimization device according to claim 3, wherein
the behavior change of the second agent is course change, acceleration, or deceleration.

5. The scenario parameter optimization device according to claim 3, wherein
in a case where a recognition start time at which the first agent starts to recognize the second agent is later than the responsibility determination time candidate, the processing circuitry detects the recognition start time as the responsibility determination time instead of the responsibility determination time candidate.

6. The scenario parameter optimization device according to claim 1, wherein
the processing circuitry determines whether or not the first agent is responsible for occurrence of the predetermined event from a situation at the responsibility determination time, and
the processing circuitry determines whether or not the first agent is responsible at the responsibility determination time on a basis of a deceleration or a turning angular velocity of the first agent necessary for avoiding occurrence of the predetermined event.

7. The scenario parameter optimization device according to claim 6, wherein
the processing circuitry determines that the first agent is responsible in a case where a behavior change of the first agent occurs after the responsibility determination time.

8. A control logic inspection system comprising:
the scenario parameter optimization device according to claim 1; and
a simulation execution device to perform a simulation test of the first agent using a scenario defined by the optimized scenario parameter and a control logic program for controlling a behavior of the first agent.

9. A scenario parameter optimization method performed by processing circuitry, the method comprising:
receiving an execution result of a simulation test of a scenario including a first agent and a second agent, executed on a basis of a scenario parameter, and calculating an object function value of a predetermined event from an object function expressing the predetermined event, and an event occurrence time at which the predetermined event occurs on a basis of the execution result;
determining whether or not the first agent is responsible for the occurrence of the predetermined event from a situation at a responsibility determination time before the calculated event occurrence time on a basis of the execution result and the calculated event occurrence time, and outputting a result of the determination as a responsibility determination result; and
optimizing the scenario parameter in such a manner that the calculated object function value decreases and the first agent is determined to be responsible for the occurrence of the predetermined event on a basis of the calculated object function value and the output responsibility determination result.

10. A non-transitory computer-readable storage medium having stored therein a scenario parameter optimization program to cause a computer to execute:
a function of receiving an execution result of a simulation test of a scenario including a first agent and a second agent, executed on a basis of a scenario parameter, and calculating an object function value of a predetermined event from an object function expressing the predetermined event, and an event occurrence time at which the predetermined event occurs on a basis of the execution result;
a function of determining whether or not the first agent is responsible for the occurrence of the predetermined event from a situation at a responsibility determination time before the calculated event occurrence time on a basis of the execution result and the calculated event occurrence time, and outputting a result of the determination as a responsibility determination result; and
a function of optimizing the scenario parameter in such a manner that the calculated object function value decreases and the first agent is determined to be responsible for the occurrence of the predetermined event on a basis of the calculated object function value and the output responsibility determination result.
